(19) United States
(12) Patent Application Publication
(10) Pub. No.: US 2015/0100461 A1
(43) Pub. Date: Apr. 9, 2015

(54) Robotic System Controlled by Multi Participants

(71) Applicants: Dan Baryakar, Hod-Hasharon (IL); Andreea Baryakar, Hod-Hasharon (IL)

(72) Inventors: Dan Baryakar, Hod-Hasharon (IL); Andreea Baryakar, Hod-Hasharon (IL)

(21) Appl. No.: 14/045,822

(22) Filed: Oct. 4, 2013

(51) Int. Cl. B25J 19/02; B25J 9/16; G06Q 30/06; B25J 13/00; B25J 5/00; A47F 13/00; B25J 11/00

(52) U.S. Cl. CPC B25J 19/023; A47F 13/00; B25J 9/16; B25J 9/1602; B25J 11/008; B25J 13/006; B25J 5/00; G06Q 30/0617; Y10S 901/01; Y10S 901/02; Y10S 901/47
USPC 705/26.43; 700/264; 700/259; 700/248; 700/213; 901/1; 901/2; 901/47

(57) ABSTRACT

Mobile robotic system allows multiple users to visit authentic places without physically being there. Users with variable requirements are able to take part in controlling a single controllable device simultaneously; users take part in controlling robot's movement according to their interest. A system administrator selects and defines criteria for robot's movement; the mobile robot with video and audio devices on it is remotely controlled by a server which selects the robot's movement according to the users and system administrator criteria. The server provides information to users; the robot's location influences the content of the information. Such robotic system may be used for shopping, visiting museums and other public touristic attractions over the Internet.

### CROSS-REFERENCE TO RELATED APPLICATIONS

This application is a continuation-in-part application of International Application No. PCT/IL2012/050045 with international filing date 13 Feb. 2012, and claiming benefit from U.S. Patent Application No. 61/474,368 filed 12 Apr. 2011, and U.S. Patent Application No. 61/530,180 filed 1 Sep. 2011, all hereby incorporated in their entirety by reference.

### FIELD OF THE INVENTION

The present invention relates to remotely controlled systems generally and to a remotely controlled system with multiple users in particular.

### BACKGROUND OF THE INVENTION

Robots are generally electro-mechanical machines capable of moving, or having moving parts, which may be used to assist humans in carrying out diverse functions in varied applications. They generally include a controller and may include other hardware, software, and firmware, some or all of which may be included as part of a detection and guiding system for controlling its movement and/or that of its moving parts.

Robots may be used in almost all aspects of daily life. As an example, they may be used in industrial applications to perform tasks which may be highly repetitive, for lifting heavy components or equipment, among numerous other applications. They may also be used, for example, to prevent exposing personnel to hazardous situations typically associated with military and other security-related applications, or with mining and complex constructions applications, or even with space exploration applications where repair tasks may be required to be performed outside of a space vehicle. Other applications may include, for example, more domestic-related uses such as for cleaning a home, for serving foods and beverages, and even for assisting with food and other item shopping. A robot for assisting with shopping is described in U.S. Pat. No. 7,147,154 B2 which discloses “A method and system for assisting a shopper in obtaining item(s) desired by the shopper is disclosed. The method and system include allowing the shopper to provide the item(s) to a computer system and determining location(s) of the item(s) using the computer system. The method and system also include determining a route including the location(s) using the computer system. In one aspect, the method and system also include allowing the shopper to edit the at least one item after the route has been determined, determining an additional location for a new item using the computer system if a new item has been entered, and re-determining the route based on the shopper editing the at least one item using the computer system. In another aspect, the computer system resides on a robotic shopping cart. In this aspect, the method and system also include automatically driving the robotic cart to each of the location(s).”

Robots frequently form part of robotic systems which generally include means to allow a user to remotely control the robot's operation. The robotic system may include use of a server-based communication network which may include the Internet over which the user and a device controller may communicate with the robot. US Patent Application Publication No. 2010/0241693 A1 to Ando et al. discloses “A remote operation robot system for having a robot perform a task by remote operation, the system comprising: an operated device connected to a communication network, for functioning to perform the task in accordance with a remote operation via the communication network; an operating terminal connected to a communication network, for operating the operated device via the communication network; and a server for holding operated side information about a request, from a device user of the operated device, to have the task performed, and operating side information about a request, from a terminal operator of the operating terminal, to perform the task, determining a combination of the operated device and the operating terminal that operates the operated device based on the operated side information and the operating side information, and notifying the operated device and the operating terminal of the combination, wherein the operated device includes a device state obtaining unit for obtaining the device state measured by an input device which is at least either one of a camera, a microphone, an acceleration sensor, an ultrasonic sensor, an infrared sensor, and an RFID tag sensor, judges dynamically whether to perform the task autonomously or to have the task performed by the remote operation, and when it is judged to have the task performed remotely, notifies the server of the operated side information, requests the server to determine the operating terminal for performing the task, and transmits device state information obtained by the device state obtaining unit to the operating terminal for performing the task.”

Other related art includes U.S. Pat. No. 6,658,325; US 2003/0236590; WO 2010/062798; US 2007/0276558; US 2007/0061041; US 2010/0241693; U.S. Pat. No. 7,282,882; U.S. Pat. No. 7,904,204; US 2010/0131102; US 2008/0234862; US 2009/0234499; US 2008/0222283; US 2010/0324731; U.S. Pat. No. 7,147,154; WO 2012/022381; US 2011/0118877; US 2010/0191375; and U.S. Pat. No. 7,346,429.

### SUMMARY OF THE PRESENT INVENTION

The objective of the present invention is to provide a method which allows two or more users to control and get information from a single controllable device, in order to prevent from only a single user to use a device for a cretin period of time without sharing, a situation which may lead to a long queue of users waiting the device. The objective is to increase the number of users who may benefit from the device's service.

An application is a remote shopping over the Internet by a robot with a camera on it, the robot is located within a store which allows two or more customers to move around the store at the same time and may locate, view and purchase merchandise. Moreover, the present invention provides to a system administrator an ability to influence the robot's motion; the system administrator may direct the customers to certain interesting places and places with an added business value. In some cases the system administrator may give some advantage to certain customers from a business point of view.

The process is carried out by a module which collects a variety of users' requests, necessities about the controllable device operation and also takes into consideration predetermined definitions, administrator preferences, the controllable device capabilities and surrounding limitations; the module instructs the controllable device accordingly.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a multiple users robotic system, first embodiment.

FIG. 2A is a block diagram of a robotic server's software, first embodiment.

FIG. 2B is a flow process chart of a robotic server's software, first embodiment.

FIG. 3 is an illustration of a browser user interface, first embodiment.

FIG. 4A is a flow chart of a motion task of a resolving process, first embodiment.

FIG. 4B is a flow chart of a collect task of a resolving process, first embodiment.

FIG. 5 is an illustration of a multiple users robotic system, second embodiment.

FIG. 6A is a block diagram of a robotic server's software, second embodiment.

FIG. 6B is a flow process chart of a robotic server's software, second embodiment.

FIG. 7 is an illustration of a browser user interface, second embodiment.

FIG. 8 is an illustration of an administrator interface, second embodiment.

FIG. 9A is a flow chart of a motion task of a resolving process, second embodiment.

FIG. 9B is a flow chart of a collect task of a resolving process, second embodiment.

FIG. 10A is a side view of a robot.

FIG. 10B is a front view of a robot.

FIG. 11 is a block diagram of an electrical system of a robot.

FIG. 12 is a block diagram of a software structure of a robot.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Identical numerical references (even in the case of using different suffix, such as 106, 106a, 106b and 106c, 106a-106c) refer to functions or actual devices that are either identical, substantially similar or having similar functionality.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Known robotic systems are generally configured to allow a robot to be remotely controlled by a single user operating a device controller, potentially limiting the functionality of the robot to the requirements of the single user. Some robotic systems may allow multiple users to inactively participate in the use of the robot, for example as viewers of the robot's operation, but nevertheless, control of the robot remains in the hands of the single user. Functionally limiting use of a robot to single user control may be particularly disadvantageous when multiple users require use of the robot's functionality, as there may be a limitation as to the total amount of time the robot may be used collectively by all the users or individually by each user. A possible solution may be providing each user with a robotic system with its own device controller and its own robot, but this is generally impractical as the cost of a robotic system, depending on its application may be relatively costly, and so may the deployment of the robotic system be costly and/or technically complex.

There is a need for a robotic system having a single robot remotely controlled by two or more users. A multiple users robotic system may include a user device controller which allows communicating with the robot. The two or more user-controlled device controllers may simultaneously transmit to the robot a variety of requests and necessities, control commands. The multiple users robotic system may additionally allow the multiple users to substantially simultaneously receive data. One of the objectives of the robotic system is the option to operate a few controllable devices by a larger amount of device controllers; operating the system when the number of device controllers is less or equal to the number of controllable devices may also be possible.

An application for the multiple users robotic system may allow the multiple users to participate in remote events and visit places generally associated with audio and/or visual experiences without actually requiring their physical presence at the locations and by this way to save time and expenses. For example, the multiple users robotic system may be used for remote shopping and may allow the two or more users to use the robot to locate merchandise, view merchandise and purchase merchandise. The multiple users robotic system may also be used, for example, to allow the two or more users to remotely visit a house for sale and for renting, get a better impression of a hotel before making a hotel reservation, attend exhibits in a gallery and museum, a movie and theatre presentation, a tourist attraction, a concert, a shop, a mall, a store, among many other places which may provide audio and/or visual experiences and are typically associated with requiring a user's physical presence.

### First Exemplary Embodiment

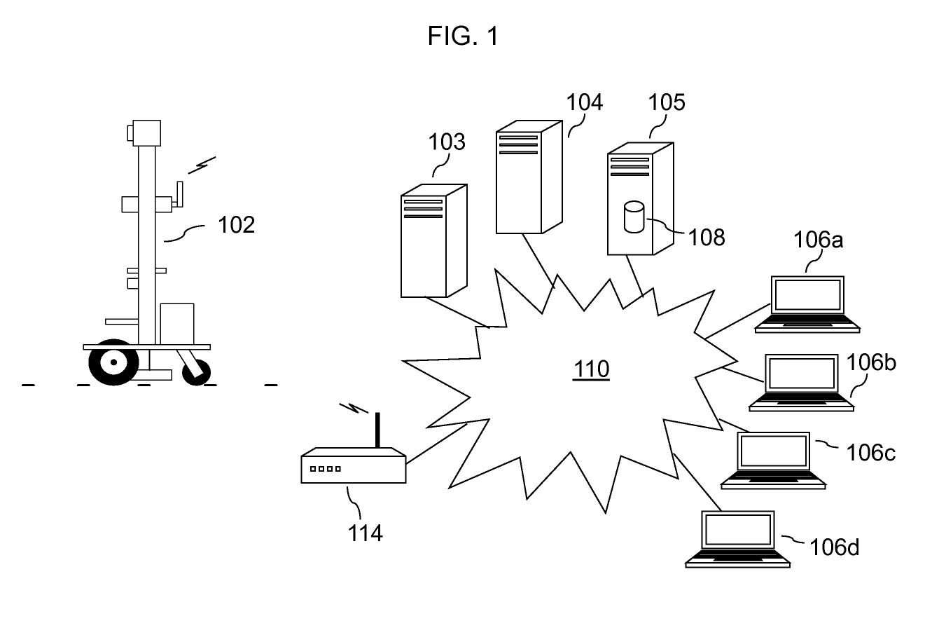

Here, an exemplary embodiment for carrying out the present invention will be described in detail by referring to the drawings. Reference is now made to FIG. 1 which illustrates the multiple users robotic system, according to the first exemplary embodiment of the present invention. Multiple users robotic system may include: a single controllable devices, for example robot 102; two or more device controllers which are operated by users, for example computers 106a-106d; a network interface, for example a wireless interface 114; a communication network, for example Internet network 110; an application server, for example a web server 103; a media server, for example a video server 104; and a control server, for example robotic server 105 and a processor, for example resolver module 108.

Robot 102 is a mobile robot remotely controlled; the robot has a camera and means to be controllable remotely by receiving operation commands and execute such operation commands. Web server 103 is a computer-based device appointed to deliver web content that can be accessed by the device controllers 106, way of example are Apache and Microsoft IIS. Video server 104 is a computer-based device appointed to broadcast real time video to the device controllers 106, way of example are Adobe Flash Media Server and Wowza Media Server. Robotic server 105 is a computer-based device appointed to control, makes decisions concerning operation of robot 102 and transfers data between system's various components. Robotic server 105 may include data processing means and storage means as may be required for its operation.

Device controllers 106 are a user means to communicate with the multiple users robotic system, information from the web server 103 and video server 104 is going to, and control commands are coming from, way of example to device controller is a computer, a laptop computer, a tablet computer, a mobile phone, a smartphone, a gaming console and a television's remote control, or any other type of stationary or mobile computing device suitable for communicating.

Resolver 108 receives and processes a variety of control commands sent by two or more users via the device controllers 106, and determines based on a predefined set of rules operation commands which are to be executed by the robot 102. The robotic server 105 includes the resolver 108, but it may locate on other devices. Resolver's rules include rules which may be associated with the robot's surroundings and the received control commands. A system with one rule is also possible, such as operating according to the most wanted control command; the current exemplary embodiment includes this rule.

Communication network 110, an Internet network may connect between wireless interface 114, device controllers 106, robotic server 105, web server 103 and video server 104. Wireless interface 114 may connect the robot 102 to the communication network 110; way of example is a wireless router using radio waves.

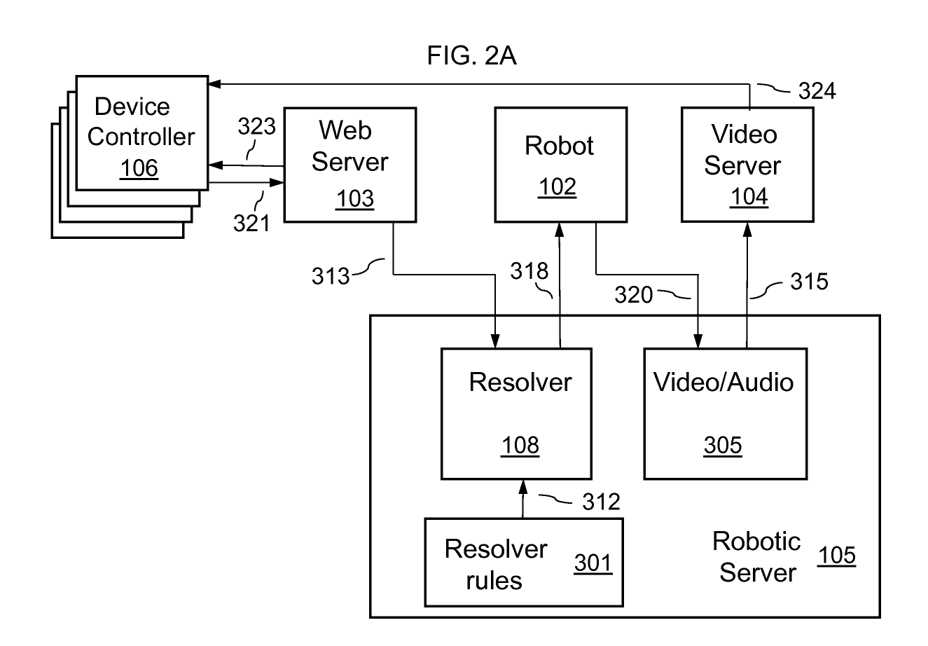

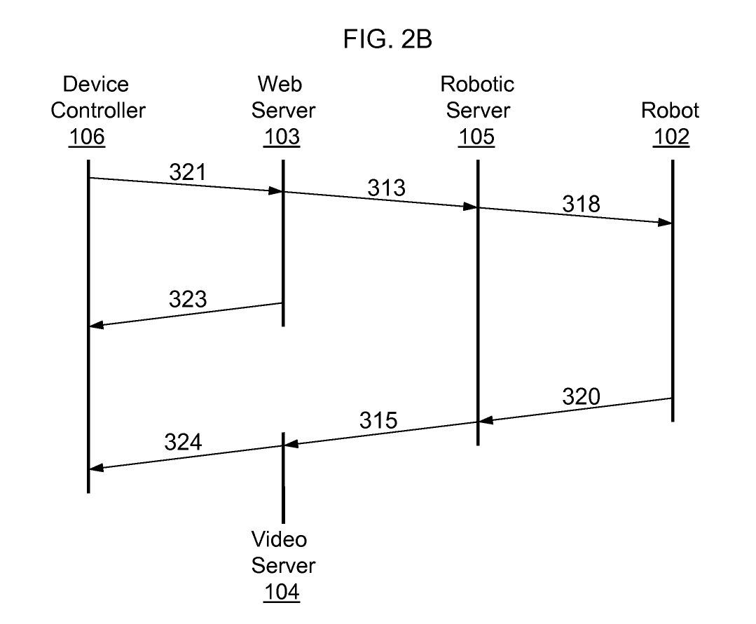

Reference is now made to FIG. 2A which shows a block diagram of the robotic server's 105 software, according to the first exemplary embodiment of the present invention; the objective of current exemplary embodiment is to decide upon the robot's 102 movements, taking into consideration a variety of users' requests.

Resolver module 108 decides repeatedly upon the robot's 102 movement by sending operation commands 318 to the robot 102, a trigger for such decision may be based on thresholds such as a number of input 321 control commands from the device controllers 106 and period of time; the resolver 108 gets 313 all device controllers' 106 control commands concerning the users' preferable movement of the robot 102.

Resolver rules module 301 includes definitions, preferences and limitations, which are embedded in the robotic server software in the current exemplary embodiment. Way of example: taking into consideration a period of time users are connected to the system in current connection and previous connections, according to users' history, registered and guest users, dates of users' purchasing, dates of entering to the system, frequency of purchasing, amount of purchasing.

The resolver module 108 takes into consideration at least of the following: present and previous users' control commands, avoiding bumping into items and resolver rules 312. For simplicity and clarity of illustration the current embodiment has only a single rule, operating according to the most wanted control command.

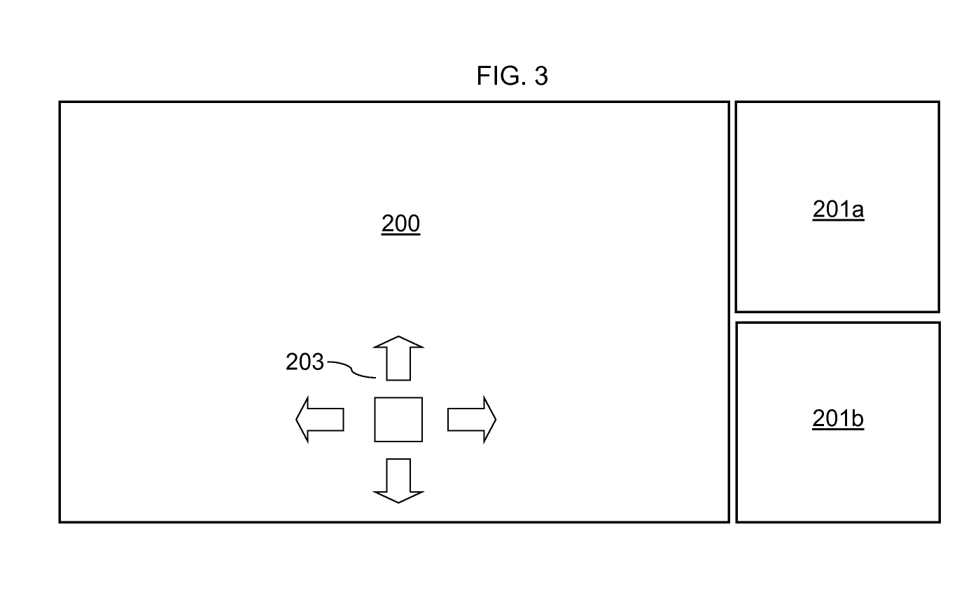

The web server 103 outputs 323 to the device controllers 106, web pages, images, video or other content for the browser pages. Way of example for browser page is FIG. 3. The interface between the device controllers 106 and the web server depends on the network 110 type; way of example is an Internet network. The users' device controllers use web browsers such as Internet Explorer and Google Chrome in case of Internet network, smart phone application and an application which may run over IP, UDP/IP and TCP/IP.

Streaming video/audio module 305 objective is to process the robot's camera captured pictures and audio 320, in the current exemplary a stream 315 of Real Time Messaging Protocol (RTMP), in order to broadcast it 324 to the users' device controllers 106 by the video server 104.

FIG. 2B shows a flow process chart of the robotic server's software, according to the first exemplary embodiment of the present invention. The upper sequence line 321, 313, 318 represents the way of users' requests by the device controllers 106 till turning into operation commands to the robot 102. The middle line 323 represents the way of web pages to the users' devices controllers 106. The lower sequence line 320, 315, 324 represents the way of captured pictures and audio from the robot's camera till turning into broadcasted video to the users' devices controllers 106.

Other embodiments may include other variations of the described embodiment, it may depend on the software and hardware architecture of the robot 102 and the robotic server 105, also some of the modules may be located on the robot 102 itself, it may also be required to duplicate some of the modules such as resolver rules 301. Many other variations of the servers 103, 104, 105 are possible, some of the modules may be eliminated; some modules may be divided among different machines such as streaming video server 104, robotic server 105 and web server 103.

Reference is now made to FIG. 3 which illustrates a browser user interface, device controller interface, a browser display used to control robot 102 by multiple users and for viewing items in a store and other compound suitable for shopping, according to the first exemplary embodiment of the present invention. The two or more users request to control the robot's movement by selecting arrows 203 while watching the robot's 102 real time video picture 200; According to a direction in which arrow 203 points, every arrow selection directs the robot 102 in a different direction. Other embodiments may use other means to control the robot movement such as: touch screen, keyboard, mouse, voice recognition, selecting an item from a list, selecting a picture and free text.

Browser may display information in windows 201a and 201b which may include predefined and recorded data, for example, a map, a location map, a picture, a video, music, voice, text, 3D virtual space, link to another web site and link to another web page.

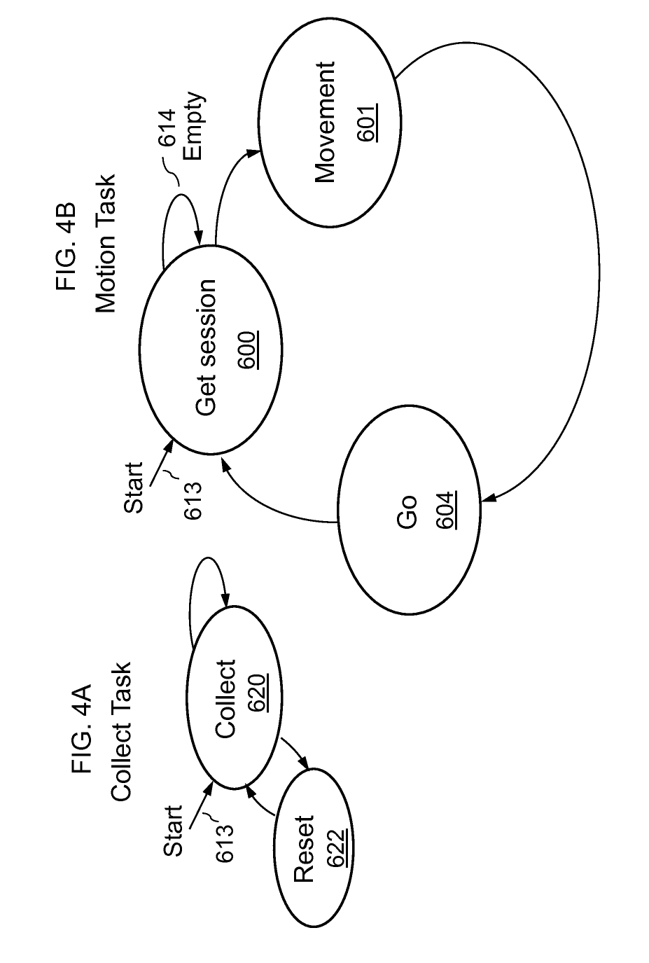

Reference is now made to FIG. 4A and FIG. 4B show a flow chart of resolving process. FIG. 4B shows a flow chart of a resolver module 108, to be implemented by motion task which is running under the robotic server 105, FIG. 4A shows a flow chart of a collect task which is running under the web server 103; according to the first exemplary embodiment of the present invention.

Collect task which is illustrated in FIG. 4A repeatedly gets a variety of control commands from the device controllers 106 and collects them into a session. Collect state 620 repeatedly gets the device controllers' 106 control commands from different users which would like to control selected robot 102; several control commands together generate a session. Collect state 620 repeatedly gets 321 the control commands, until a reset event 622 is required. Reset state 622 sends the collected control commands to motion task at FIG. 4B and starts a new collecting session of device controllers' 106 control commands. In the first exemplary embodiment in case of getting more than one control command from the same device controller during a session, only the last one will be taken into consideration; but in other embodiments more than one control command per device controller may be taken into consideration during a session.

Motion task which is illustrated in FIG. 4B is responsible for the calculation of the robot 102 motion path; the path is dynamic and may vary all the time based on the users' selecting arrows 203 control commands and resolver rules 301. Get session state 600 gets the session information 313 from the collect task and during this state the reset event 622 is also executed. Start action 613 is motion and collect tasks initialization entry; empty action 614 occurs in case the session doesn't include any users' control commands, meaning waiting for next session event. Movement state 601 finds the most wanted users' selected arrow 203 by sum all users' control command for certain direction. Go state 604 gets the most wanted direction from state 601; go state 604, during this state the robot 102 is moving in the most wanted direction from previous state 601 until a trigger of time interval for a new session is arrived. Other embodiments may have a trigger such as amount of selected control commands, a predefined time, number of connected users, speed, distance and event such as a new user connected to the system.

### Second Exemplary Embodiment

In the second exemplary embodiment the multiple users robotic system knows the location of the robot and gets data about the robot's surroundings, also the multiple users robotic system includes more than one robot.

In order to operate two or more controllable devices in the second exemplary embodiment each robot 102 may have its own resolver 108 module; each resolver may get a variety of control commands from two or more device controllers 106 which relate to a relevant robot. The amount of the device controllers is larger than the amount of the controllable devices; additionally, not necessarily the number of device controllers may also be less or equal to the number of controllable devices. Other embodiments may have a common resolver module to all the controllable devices and a combination of modules.

In order to coordinate and synchronize the operations between two or more controllable devices other embodiments may include: interaction between resolver modules, having a common resolver module and a combination of modules; for example, in order to prevent from more than one robot to do similar path. In other embodiments the system may automatically select the robot for the user in order to guide him through the optimal path and optimize each robot path.

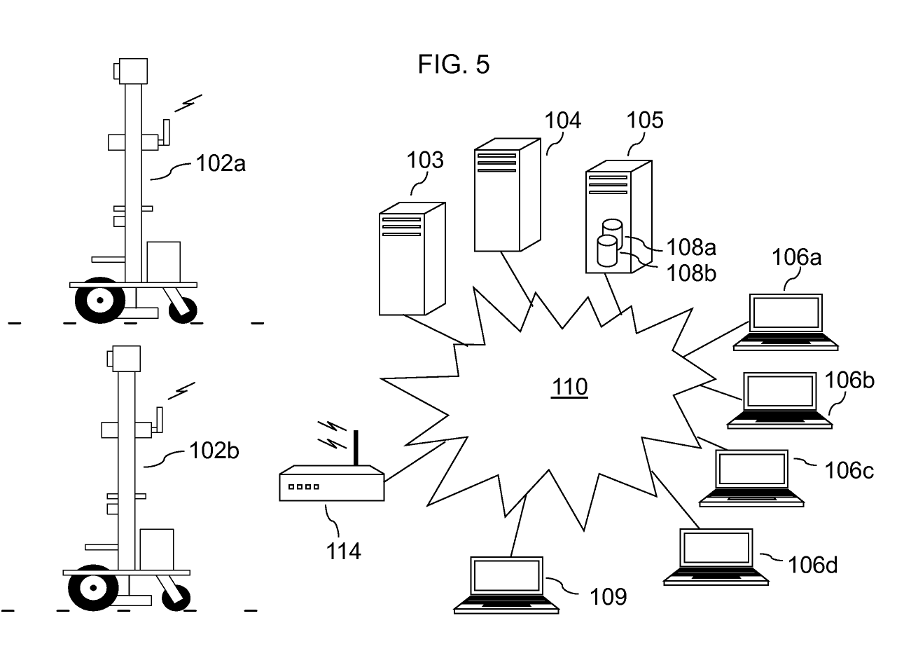

Here, an exemplary embodiment for carrying out the present invention will be described in detail by referring to the drawings. Reference is now made to FIG. 5 which illustrates the multiple users robotic system, according to the second exemplary embodiment of the present invention. The multiple users robotic system may include: one or more controllable devices, for example robots 102a and 102b; multiple device controllers which are operated by multiple users, for example computers 106a-106d; a network interface, for example a wireless interface 114; a system administrator 109, for example a person by a remote computer; a communication network, for example Internet network 110; an application server, for example a web server 103; a media server, for example a video server 104; and a control server, for example robotic server 105 and a processor, for example resolver modules 108a and 108b.

Robots 102a and 102b are a mobile robot remotely controlled; the robot has a camera and means to be controllable remotely by receiving operation commands and execute such operation commands. Other embodiments may include other controllable devices such as camera, microphone, sensor, computer and motor.

Web server 103 is a computer-based device appointed to deliver web content that can be accessed by the device controllers 106, way of example are Apache and Microsoft IIS. Video server 104 is a computer-based device appointed to broadcast real time video to the device controllers 106, way of example are Adobe Flash Media Server and Wowza Media Server. Robotic server 105 is a computer-based device appointed to control, makes decisions concerning operation of robots 102a-102b and transfers data between system's various components. Robotic server 105 may include data processing means and storage means as may be required for its operation.

Device controllers 106 are a user means to communicate with the multiple users robotic system, information from the web server 103 and video server 104 is going to, and control commands are coming from, way of example to device controller is a computer, a laptop computer, a tablet computer, a mobile phone, a smartphone, a gaming console and a television's remote control, or any other type of stationary or mobile computing device suitable for communicating. Other embodiments may include direct communication between the device controllers 106 and other modules of the multiple users robotic system such as: robot 102 and robotic server 105.

Many types of control commands may be associated with the movement of robot 102, for example the commands may include robot positioning data indicative of one or more locations to which the robot may travel, a speed of travel to the locations, and an amount of time to remain at each location; control command, not necessarily, should be an instruction, it also may be an item and/or subject that the user may be interested in, for example, customers may select an item from a list, an item which they would like to purchase, other example is learning from users' web history and browser's search history about users preferences. Additionally, not necessarily the control commands may be associated with controlling components in robot 102 such as: imaging and audio capturing components through which images and audio may be captured by the robot 102 and processed for display to the users. Additionally, not necessarily the control commands may be associated with controlling mechanical components that may allow the robot to physically manipulate items and may include, for example, selecting the items, picking them up, moving them, rotating them, or any combination thereof.

Resolver 108 receives and processes a variety of control commands sent by two or more users via the device controllers 106, and determines based on a predefined set of rules operation commands which are to be executed by the robot 102. The robotic server 105 includes the resolver 108, but it may locate on other devices. Resolver 108 implemented in software, other embodiments may include implementation in hardware and/or software.

Resolver's rules include rules which may be associated with the robot's surroundings and the received control commands; a prioritization of control commands received, that is, which control commands are more important than others; a preferential assignment to a particular device controller over other device controllers.

Other embodiments may include a resolver which may override received control commands from device controllers 106 and may control robot 102 independently based on data base of predefined set of rules. Resolver 108 may include a manual override which may allow the system administrator 109 to override the results of the resolver 108.

System administrator 109 is a person who is responsible for the configuration and definitions of the system; it is done remotely. Other embodiments may include other ways to connect to the system such as a direct connection via RS232 and USB interfaces via a laptop computer and smartphone.

Communication network 110, an Internet network may connect between wireless interface 114, device controllers 106, system administrator 109, robotic server 105, web server 103 and video server 104. Other embodiments may include a wired network and a wireless network; a way of example is an Internet network, Ethernet, cable, cell phone and telephone networks. The network may connect between all the modules of the system or part of them, part of the modules may connect directly by cord or other means to pass information.

Wireless interface 114 may connect the robot 102 to the communication network 110; way of example is a wireless router using radio waves. Other embodiments may include other media such as audio, infrared and light; however it may be done by wire link such as dedication cabling and power line communication.

A skilled person may realize that other system topologies are available, some of the modules may be located on other devices, located together and separated to more devices; way of example is a server which may include a video server, web server, robotic server and wireless interface in one device.

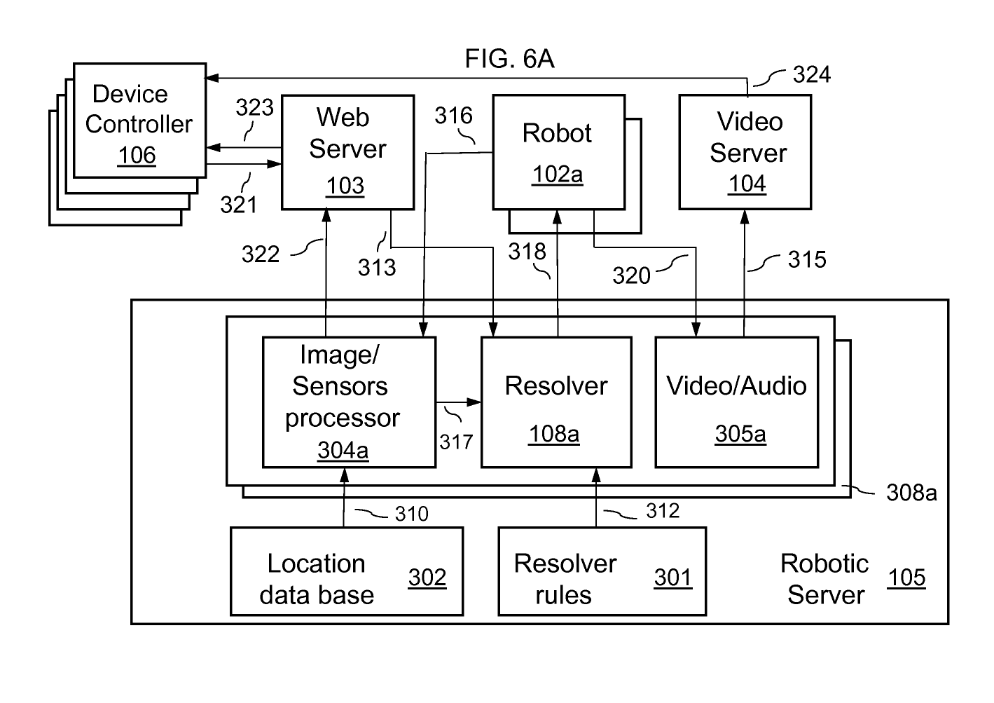

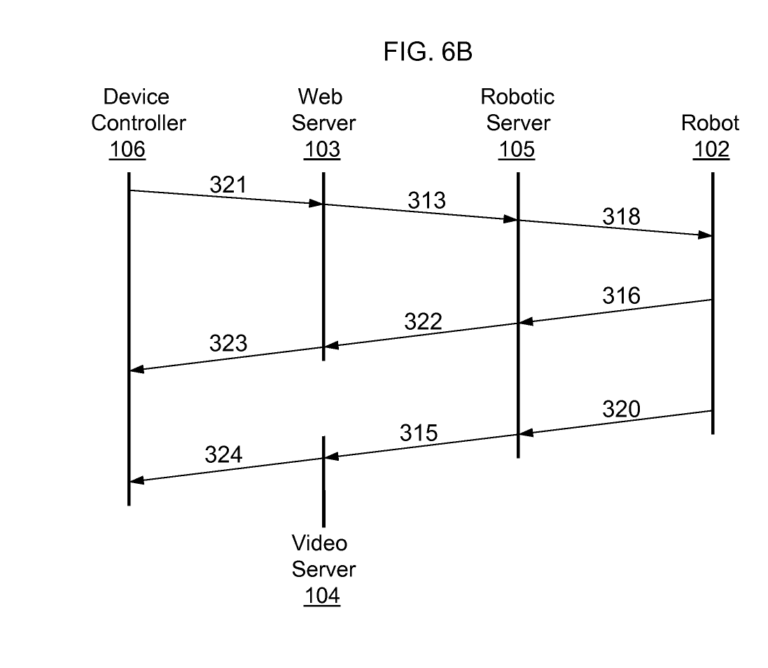

Reference is now made to FIG. 6A which shows a block diagram of the robotic server's 105 software, according to the second exemplary embodiment of the present invention. In the current exemplary every robot 102a and 102b has its own control and streaming module 308 which include Image/sensors processor module 304a, resolver module 108a, video/audio module 305a. Resolver rules module 301 and location data base module 302 are common to the entire system in the current exemplary but on other embodiments it may be per robot or other combination may be used. The objective is to decide upon the robot's 102 movements, taking into consideration a variety of users' requests, reflecting users' priority and system administrator preferences.

Resolver module 108a decides repeatedly upon the robot's 102a movement path by sending operation commands 318 to the robot 102a, a trigger for such decision may be based on thresholds such as a number of input 321 control commands from the device controllers 106, distance and period of time; the resolver 108a gets 313 all device controllers' 106 control commands concerning the users' preferable movement of the robot 102a.

Image/sensors processor module's 304a objective is to find the current location of the robot 102a, the view direction of the camera which is located on the robot and the items that the users are looking at. The image/sensors processor module 304a gets input 316 from the robot's sensors such as digital compass, RF reader, barcode reader, ultrasonic range finder and camera. The input 316 data is processed together with location data base information 310 in order to find the location and direction of the robot 102a. Viewing items is an outcome of signal processing of the camera photographs and video frames. Robot's location and viewing items are an output 317, 322 from the image/sensors processor 304a module to the resolver 108a and to the web server 103. Location data base 302 may also include a collection of lines/plains which may limit the space where the robot 102 can move within, lines/plains may be physical boundaries such as a wall and a virtual line/plain that the system administrator 109 does not allow the robots 102 to pass; such relevant information may pass to the resolver module 108 with the robot's location 317. Additionally, not necessarily other embodiments may include self-learning of common visited places.

Resolver rules module 301 includes definitions, preferences and limitations of the system administrator 109 and those which are embedded in the robotic server software. Way of example: taking into consideration a period of time users are connected to the system in current connection and previous connections, according to users' history, registered and guest users, dates of users' purchasing, dates of entering to the system, frequency of purchasing, amount of purchasing and specific area and location.

The resolver module 108 takes into consideration at least of the following: current robot's location, present and previous users' control commands, avoiding bumping into items, avoiding repeating robot's path and resolver rules 312.

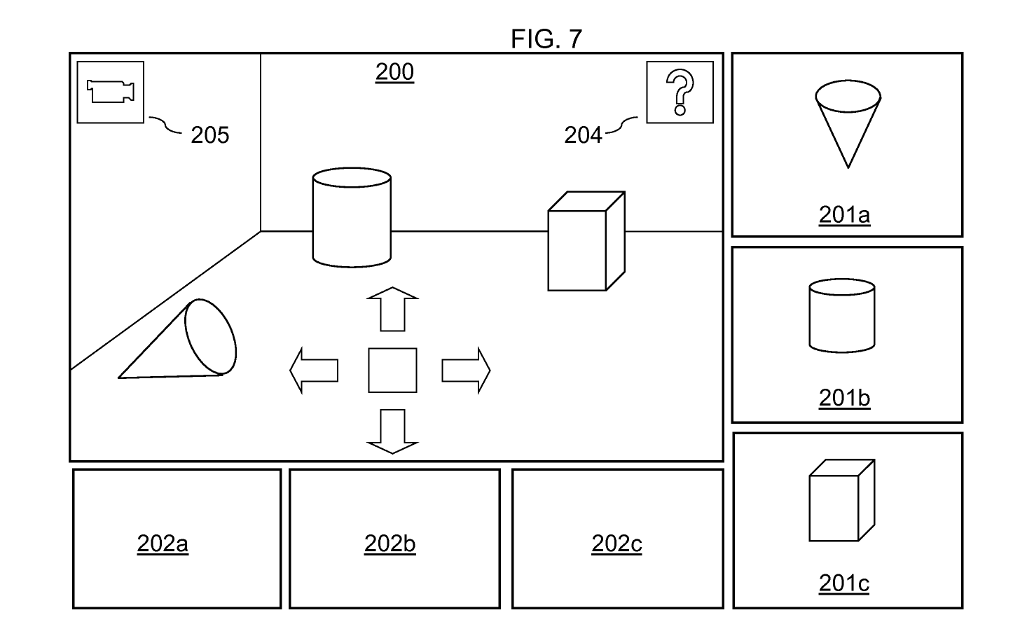

The web server 103 outputs 323 to the device controllers 106, web pages, images, video or other content for the browser pages. The content of the browser pages may depend on the location, direction of the robot 102 and viewing items. Way of example for browser page is FIG. 7. The interface between the device controllers 106 and the web server depends on the network 110 type; way of example is an Internet network, Ethernet, cable, cell phone and telephone. The users' device controllers may use web browsers such as Internet Explorer and Google Chrome in case of Internet network, smart phone application and an application which may run over IP, UDP/IP and TCP/IP.

Streaming video/audio module's 305a objective is to process the robot's camera captured pictures and audio 320, in the current exemplary a stream 315 of Real Time Messaging Protocol (RTMP), in order to broadcast it 324 to the users' device controllers 106 by the video server 104. The audio may be received from the camera's microphone or from a separate microphone.

FIG. 6B shows a flow process chart of the robotic server's software, according to the second exemplary embodiment of the present invention. The upper sequence line 321, 313, 318 represents the way of users' requests by the device controllers 106 till turning into operation commands to the robot 102. The middle sequence line 316, 322, 323 represents the way of image and sensors data from the robot 102 till turning into web pages at the users' devices controllers 106. The lower sequence line 320, 315, 324 represents the way of captured pictures and audio from the robot's camera till turning into broadcasted video to the users' devices controllers 106.

Other embodiments may include certain resolver rules 301, which are giving high preference to users; it may lead to full control of a single user. Additionally, not necessarily, not all the users may have permission to control the robot 102, some of them may only view the robot's 102 media such as video and audio; depending on the application and users privilege.

Other embodiments may include certain resolver rules 301 which lead the resolver 108 to ignore the users' control commands, by way of example is that although the users direct the robot 102 in a certain direction the resolver 108 will select another direction since it leads to a priority area, another way of example is that although the users direct the robot 102 in a certain direction the resolver 108 will direct the robot 102 to stay in a certain area for a period of time.

Other embodiments may include other variations of the described embodiment, it may depend on the software and hardware architecture of the robot 102 and the robotic server 105, also some of the modules may be located on the robot 102 itself, it may also be required to duplicate some of the modules such as resolver rules 301 and location data bases 302. Many other variations of the servers 103, 104, 105 are possible, some of the modules may be eliminated such as at the first exemplary embodiment; some modules may be divided among different machines such as streaming video server 104, robotic server 105 and web server 103.

Reference is now made to FIG. 7 which illustrates a browser user interface, device controller interface, a browser display used to control robots 102 by multiple users and for locating, viewing and purchasing merchandise in a store and other compound suitable for shopping, according to the second exemplary embodiment of the present invention. Multiple users request to control the robot's movement by selecting arrows 203 while watching the robot's 102 real time video picture 200; According to a direction in which arrow 203 points, every arrow selection directs the robot 102 in a different direction. Other embodiments may include options to select other operation such as speed, direction, rotation, camera zoom in/out and a combination of them. Additionally, not necessarily other embodiments may use other means to control the robot movement such as: touch screen, keyboard, mouse, voice recognition, selecting an item from a list, selecting a picture and free text.

Based on the robot's 102 position and direction, browser may display information in windows 201a-201c which may include predefined and recorded data, for example, a map, a location map, a picture, a video, music, voice, text, 3D virtual space, link to another web site and link to another web page. Way of example is a picture of merchandise, and the user may purchase item by selecting the proper display window 201; additionally, not necessarily the user may purchase merchandise by selecting the item from a video, for example, video picture 200.

When more than one robot is in operation at the same time in the system, the browser display may show the user all robots' real time video streaming 202. Selecting one of the video streaming 202a-202c connects the user to the selected robot's 102 video streaming; large video streaming 200 belongs to the selected robot. Another option may be automatic selection of the robot by the web server 103.

In some applications such as shopping, browser may include an option to have a help icon 204, the purpose is to add the possibility of getting help 1:1 (salesperson: customer) while selecting the icon the user switches to another robot, the number of helper robots may be equal to the number of salespersons in a store. Browser may include a video icon 205 which may be selected by the user for taking a tour of a prerecorded video, when it appears it implies that the user may quit and take a tour of prerecorded video, and may return to the group afterwards.

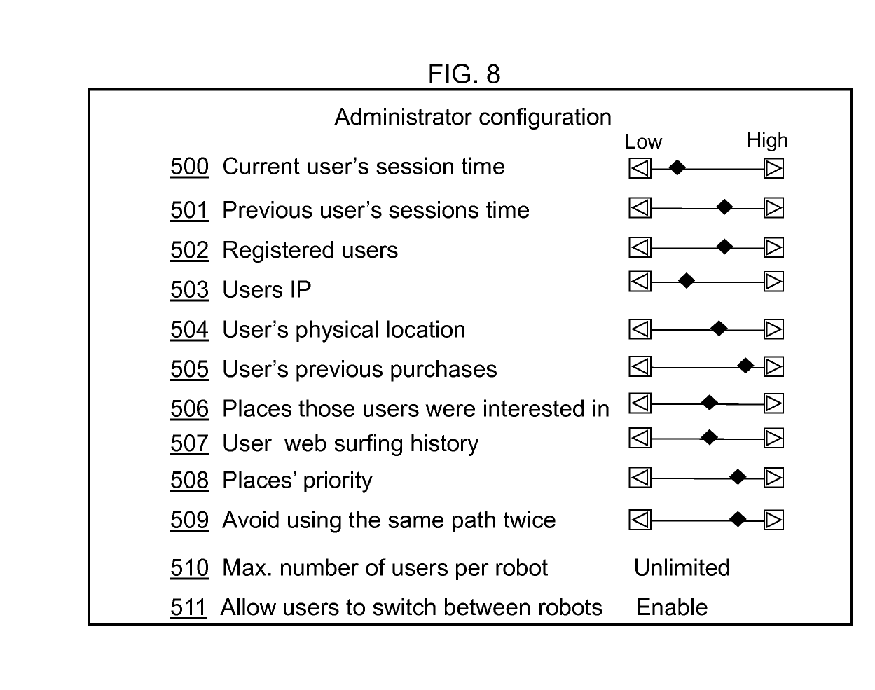

Reference is now made to FIG. 8 which illustrates the system administrator 109 interface to determine rules and priority criteria, according to the second exemplary embodiment of the present invention. The resolver 108 may take into consideration below set of criteria:

a. Current user's session time 500 may lead to increasing or decreasing the given preference to the user according to the current period of time the user is connected to the system;
b. previous user's sessions time 501 may lead to increasing or decreasing the given preference to the user, and may include duration and date of previous connection to the system;
c. registered user 502 may lead to increasing or decreasing the given preference to the user comparing to guest users.
d. user's IP address 503 which may include IP physical location mapping or device controllers' 106 subnet;
e. user's physical location 504 which may include information which may be relevant to registered users who submitted their address during registration;
f. user's previous purchases 505 which may include the sum of the purchases and dates of purchasing;
g. places those users may be interested 506 and which may be based on users' history, current connected or not connected users, may be limited or unlimited in time.
h. user's web surfing history 507 which may include user's selections of web pages at the site, and may not be limited to the robot's web pages;
i. places' priority 508 which may include selecting the preference of the places based on the location data base 302;
j. avoid using a same path twice 509 which may include monitoring places and paths current connected users have visited;
k. maximum number of users per robot 510 which may include limiting a number of users per robot; and
l. allow users to switch between robots 511, and which may include automatically assigning users to robots, or users having a privilege of selecting the robots.

The above rules are considerations of exemplary, non-limiting predetermined rules and priority criteria which may be used, although the skilled person may realize that many other considerations regarding rules and priority criteria may be employed depending on the system application.

The system administrator's definitions may have different types of user interfaces; other ways of example are onboard jumpers and definitions which may be embedded in software code.

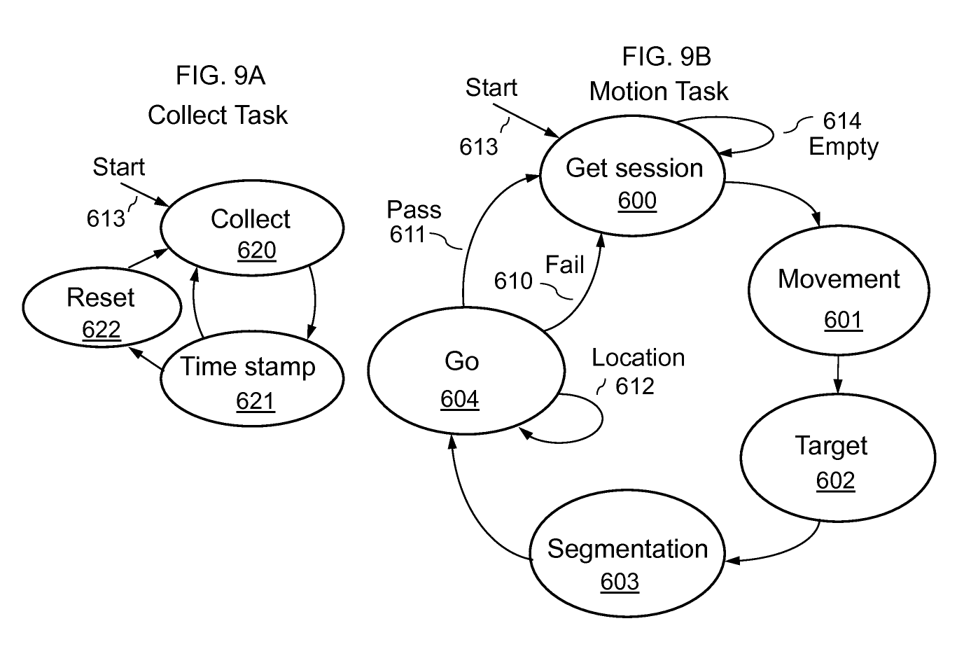

Reference is now made to FIG. 9A and FIG. 9B show a flow chart of resolving process. FIG. 9B shows a flow chart of a resolver module 108, to be implemented by motion task which is running under the robotic server 105, FIG. 9A shows a flow chart of a collect task which is running under the web server 103; according to the second exemplary embodiment of the present invention.

Collect task which is illustrated in FIG. 9A repeatedly gets a variety of control commands from the device controllers 106 and collects them into a session. Collect state 620 repeatedly gets device controllers' 106 control commands from different users which would like to control selected robot 102; several control commands together generate a session. Collect state 620 gets 321 the control commands and adds the relevant information about the users; a way of example for such information are: current users connection time, registered users or guest users, users' location according to users' registration information and device controllers' IP. Time stamp state 621 marks the arrival time of the control commands; the time since the session started. After the time stamp was added it returns back to collect state 620 in order to process the next control command from other user, in case reset event 622 is not required. Reset state 622 restarts the time stamp timer, sends the collected control commands with the relevant information to motion task at FIG. 9B and starts a new collecting session of device controllers' 106 control commands information. In the second exemplary embodiment in case of getting more than one control command from the same device controller during a session, only the last one will be taken into consideration; but in other embodiments more than one control command per device controller may be taken into consideration during a session.

Motion task which is illustrated in FIG. 9B is responsible for the calculation of the robot 102 motion path; the path is dynamic and may vary all the time based on the users' selecting arrows 203 control commands and resolver rules 301. Get session state 600 gets the session information 313 from the collect task and during this state the reset event 622 is also executed. Start action 613 is motion and collect tasks initialization entry; empty action 614 occurs in case the session doesn't include any users' control commands, meaning waiting for next session event. Movement state 601 scores each user's control command in the current session, scores each user's control command based on collect state 620 added information, time stamp 621 and system administrator 109 priority; by way of example is a registered user which is located in prioritized place, system administrator priority for registered users is 8 and for prioritized places is 5, the score is going to be 8+5 which is 13 and adjusts the score by increasing or decreasing it according to the arrival time stamp from state 621. Finds the most wanted users' selected arrow 203 by summing up all users' control command scores for certain direction. Target state 602 gets the most wanted direction from previous state 601 and finds a new motion path, in the wanted direction, to a new target location to move to; based on current location input 317 and location data base information 302 such as area, path or specific location with adjustments of administrator priority and distance from current location, finds a motion path.

Other embodiments may take into consideration not only the most wanted direction from movement state 601, but also may include other directions with adjustments priority. Additionally, not necessarily other embodiments in case the session includes none or fewer users' control commands the target may be based on the resolver rules 301 and location data base information 302.

Segmentation state 603 used in case the target destination from previous state 602 is too far, the target path may be divided into segments, the end of the first segment is defined as a new target. Go state 604, during this state the robot 102 is aiming to arrive to the target destination. Fail 610 is declared since a new target destination is required due timeout and physical barrier. Other embodiment may declare fail since a certain number of users left or joined the system, a certain number of users requested different motion direction, a predefined time, number of connected users, specific user connected to the system, amount of selected control commands and distance. Pass action 611 is declared in case the robot 102 arrived to target destination. Location action 612 gets the current location from sensors processor 304 module in order to track the target path.

FIG. 9A and FIG. 9B illustrate an exemplary embodiment which is based on the users' selecting arrows 203 control commands, other embodiments may be based on other types of users interface such as: questionnaire which the users fill during the connection session, selecting a zone and a location from a map, selecting an item from a list, selecting an item from a picture, selecting a subject from a list and free text.

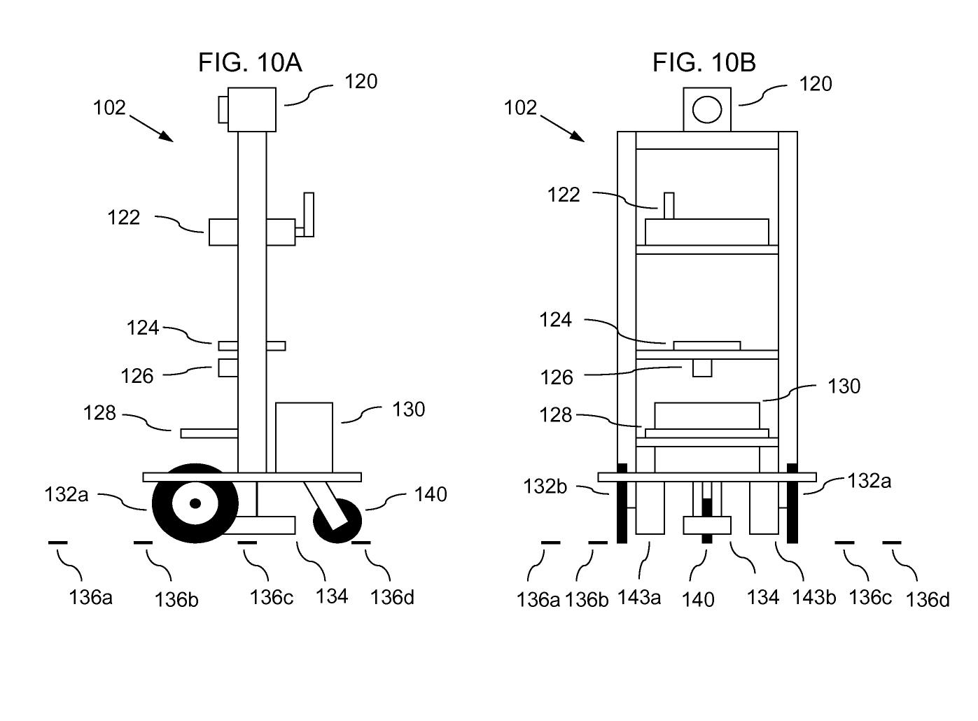

FIGS. 10A, 10B, 11 and 12 illustrate the robot 102 according to the second exemplary embodiment of the present invention. Reference is now made to FIG. 10A which shows a side view of the robot 102 and to FIG. 10B which shows a front view of the robot 102, according to the second exemplary embodiment of the present invention. Camera 120 passes video and pictures to the robotic server 105. A single or a number of cameras may be used; the camera type is one or more 2D, 3D, IR and HD. Wireless access point 122 links between the robot 102 and the server 105 via the wireless network interface 114 to forward real time data by way of example is video, pictures, voice, music, commands and status. Digital compass 124 provides the robot's direction of movement and view; the data is used for locating the robot's direction and provides the users relevant data accordingly. Main board 128 forwards the audio and video data from the camera 120 to the server 105; executes the server 105 operation commands by activating motors 143a, 143b; translates the analog data form the ultrasonic ranger finder 126 to digital data and passes it to the server 105; gets data from an RF reader 134 and forwards it to the server 105; processes the digital compass 124 data and forwards it to the server 105.

Ultrasonic range finder 126 sensor enables the robot 102 to prevent from bumping into objects in its way. Battery 130 or any other power supply means by way of example is a power cord, wireless energy transfer and solar power; is used to drive the motors 143, the main board 128, the camera 120, the ultrasonic range finder 126, the wireless access point 122, the digital compass 124 and the RF reader 134. Two stepper motors 143a and 143b are used to drive front wheels 132 forward and backward; any means to move the robot may be used such as a stepper motor, DC motor and AC motor, with or without rotary transmission means. Two front wheels 132 left, right and a rear swivel wheel 140; however it may have different motion means by way of example are tank treads and a joint system. The RF reader 134 reads tags 136 and passes the read data to the main board 128 which gives the possibility to identify the robot's 102 accurate location or zone. The RF tags 136 are spread in predefined locations; every tag has its own ID; other methods are also suitable to get the robot's location such as image processing.

Many other variations of the robot 102 are possible, for example in the first exemplary embodiment a robot without digital compass, ultrasonic range finder and RF reader may be used. Both exemplary embodiments may use the same robot with few differentness, in general it differs since in the first exemplary the robotic system isn't aware of the location and direction of the robot 102.

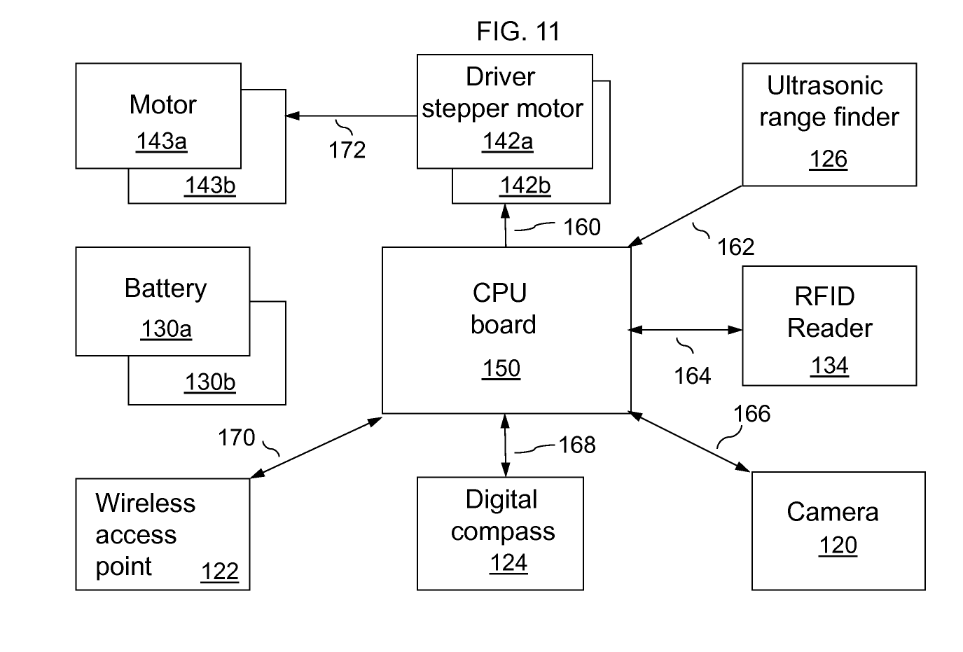

Reference is now made to FIG. 11 which shows a block diagram of an electrical system of the robot 102, according to the second exemplary embodiment of the present invention, other embodiments may include other chipsets. CPU board 150 type M52259DEMOKIT, a Freescale MCF52259 demonstration board. Driver stepper motor 142 type Sparkfun Easy driver stepper motor, the driver module is based on Allegro A3967 driver chip, connected to the CPU board 150 by PWM 160 interface; the main board 128 consists of CPU board 150 and two drivers stepper motor 142. Motors 143 type Sparkfun 4-wire stepper motor SM-42BYG011-25, connected 172 to the driver stepper motor 142 by DC voltage. Camera 120 type Microsoft VX3000, connected to CPU board 150 by a USB 166 interface. Digital compass 124 type CMP03, the compass module uses a Philips KMZ51 magnetic field sensor, connected to CPU board 150 by I2C 168 interface. Wireless access point 122 type Edimax EW-7206, connected to CPU board 150 by Ethernet 170 interface. RF reader 134 type 125 kHz, connected to the CPU board 150 by RS232 164 interface. Battery 130a type 6V 4.5AH is the supplier for the CPU board 150, the camera 120 and the digital compass 124. Battery 130b type 12V 4.5AH is the supplier for the stepper motors 143, driver stepper motor 142, the wireless access point 122 and the RF reader 134. Sensor, ultrasonic range finder 126 type Maxbotix LV EZ0, connected to the CPU board 150 by analog voltage 162 interface.

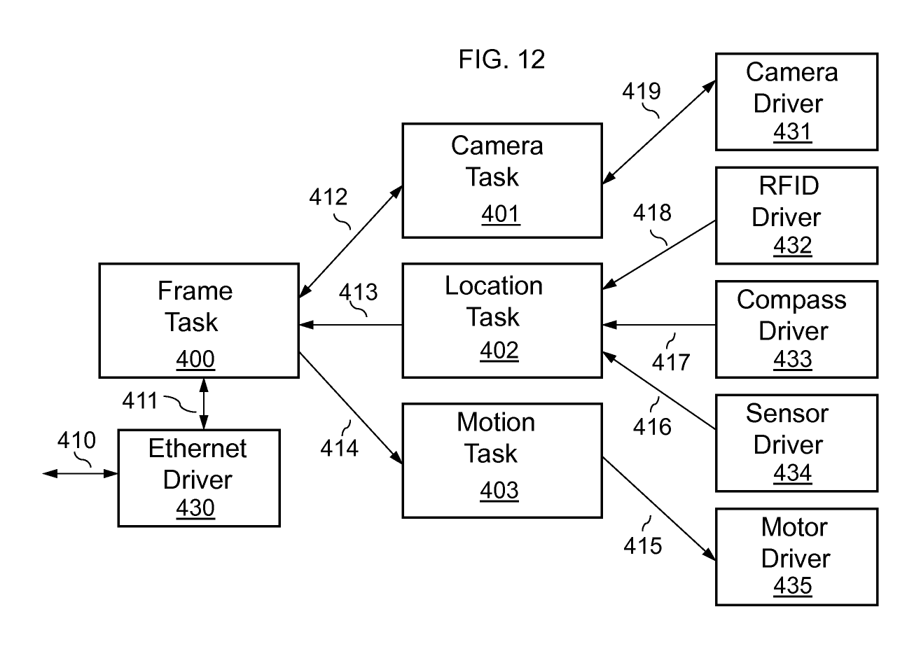

Reference is now made to FIG. 12 which shows a block diagram of a software structure of the robot 102, according to the second exemplary embodiment of the present invention. There are four tasks: frame task 400, camera task 401, motion task 403 and location task 402.

The frame task 400 receives Ethernet frames 411 and passes the relevant frames' payload 412, 414 to the camera task 401 and motion task 403 according to proprietary payload header. Frame task 400 receives payload 412, 413 from the camera task 401 and location 402 task; adds a proprietary payload header plus encapsulates it with Ethernet frame header and passes it 411 to an Ethernet driver 430. Ethernet driver 430 runs under the frame task 400, controls the Ethernet interface 170 on the CPU board 150. Camera task 401 receives 419 from a camera driver 431 segments of JPEG frames, monitors them and passes 412 them to the frame task 400 as one JPEG frame. The camera task 401 receives 412 control frames such as zoom in/out and resolution size. The camera driver 431 runs under the camera task 401 controls the USB interface 166 on the CPU board 120. Location task 402 collects 416, 417, 418 data from a sensor driver 434, compass driver 433 and RFID driver 432, packs it together in proprietary payload and passes 413 it to the frame task 400. Motion task 403 receives 414 control frames such as: forward, backward, left turn, right turn and speed. The motion task 403 translates 415 the control frame to the motor driver's 435 actions. The motor driver 435 which runs under the motion task 403 controls the PWM interface 160 on the CPU board 150.

Many other variations of the robot's software structure are possible, for example in the first exemplary embodiment a software structure without location task 402, RFID driver 432, compass driver 433 and sensor driver 434.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description. In addition, embodiments of the present invention are not described with reference to any particular programming language. It will be appreciated that a variety of programming languages may be used to implement the teachings of the invention as described herein.

While certain exemplary embodiments have been described and shown in the accompanying drawings, it is to be understood that such embodiments are merely illustrative of and not restrictive on the board invention, and that this invention not be limited to the specific constructions and arrangements shown and described, since various other modifications may occur to those ordinarily skilled in the art.

What is claimed is:

1. A control system comprising:
a single controllable device;
two or more remote device controllers which are operated by users;
and a module to receive a variety of control commands from said two or more device controllers, resolves said variety of control commands and instructs said controllable device accordingly;
whereby said control system remotely controls controllable device by multiple users at the same time.

2. The control system of claim 1, further including a network communication module to communicate with said remote device controllers over a network.

3. The control system of claim 1 wherein said a controllable device is at least a robot, a camera and a motor.

4. The control system of claim 1 wherein said device controller is stationary or mobile computing device suitable for communicating at least a computer, a laptop computer, a tablet computer, a mobile phone, a smartphone, a gaming console and a television's remote control.

5. The control system of claim 1 and wherein said module resolves said variety of control commands by taking into consideration additional data according to predetermined definitions, administrator preferences, controllable device capabilities and surrounding limitations.

6. The control system of claim 1 and wherein said module resolves said variety of control commands by prioritized said two or more device controllers.

7. The module of claim 6 and wherein said prioritized said two or more device controllers based on at least a period of time said device controller is connected to the system and the device controller location.

8. The control system of claim 1, further including forwarding real time, predefined and recorded data to said device controllers.

9. The forwarding data of claim 8 wherein said data is based on said controllable device location, direction, speed and surroundings.

10. The control system of claim 1, further including one or more controllable devices, when the amount of said device controllers is larger than the amount of said controllable devices.

11. The control system of claim 10, further coordinating and synchronizing the operations between two or more said controllable devices.

12. The control system of claim 1 wherein said module transmits instructions to said controllable device due to at least a predefined time, a time interval, a number of connected users, an amount of received control commands, a speed, a distance, an event and a location.

13. The control system of claim 1 wherein said module instructs said controllable device about at least a direction, a target location and a speed.

14. The control system of claim 1 wherein said control command is a user request for at least a direction indication, a speed indication, a zone, a location, an item, a subject indication and manipulate items.

15. A method for controlling system, comprising the steps of:
(a) providing a single controllable device;
(b) providing two or more remote device controllers which are operated by users;
(c) providing a module to receive a variety of control commands from said two or more device controllers;
(d) resolving said variety of control commands by said module;
(e) instructing said controllable device according to resolved operation by said module;
(f) activating said operation by said controllable device;
whereby said control system remotely controls controllable device by multiple users at the same time.

16. A remote shopping robotic system comprising:
a single robot with camera on it located within a store;
two or more remote device controllers which are operated by customers;
and a module to receive a variety of control commands from said two or more device controllers, resolves said variety of control commands and instructs said robot to move around said store accordingly;
whereby said remote shopping robotic system allows multiple customers to visit store by single robot at the same time.

17. The remote shopping robotic system of claim 16 further including purchasing merchandise by one or more customers.

18. The remote shopping robotic system of claim 16 further including an online store interface to provide information about merchandise seen.

19. The remote shopping robotic system of claim 16 wherein said module taking into consideration history of said customers' purchases at least sum paid and dates.

20. The remote shopping robotic system of claim 16 further located within places which provide visual experiences at least a shop, a mall, a hotel, a museum, a gallery, an exhibition, a house for sale, a house for renting and a tourist site.
